(19) United States
(12) Patent Application Publication
(10) Pub. No.: US 2008/0186881 A1
(43) Pub. Date: Aug. 7, 2008

(54) System For Distributing Radio Signal

(75) Inventors: Karl-Axel Ahl, Malmo (SE); Hans Herdensio, Huddinge (SE); Rickard Soderqvist, Tullinge (SE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: NORTHSPARK AB

(21) Appl. No.: 11/719,341

(22) PCT Filed: Nov. 15, 2005
(86) PCT No.: PCT/SE05/01729

§ 371 Date: Nov. 13, 2007

(30) Foreign Application Priority Data
Nov. 15, 2004 (SE) 0402794-2

(51) Int. Cl. H04B 7/00

(52) U.S. Cl. 370/310

(57) ABSTRACT

A method for distributing radio band signals between stations in a broadband structure. Radio band signals transmitted from a first station are converted to intermediate signals for transfer through a wire connection while maintaining code structure and modulation of the radio signals. The intermediate signals transferred over the wire connection are received and converted to radio band signals while maintaining code structure and modulation of the radio signals. A system and a method for transmitting radio signals in a broadband structure including a first network, said first network operating on air as a first medium. Said first network is connected to a second network through a first media converting means for converting the radio signals for transfer through the second network, said second network operating on wire as a second medium. The second network is connected to a third network through at least a second media converting means, said third network operating on a medium different from the second medium. The media converting means are designed to maintain code structure and modulation of the radio signals and stations of the first network are operatively connected to stations of the third network.

### TECHNICAL FIELD

The invention relates to a system for transmitting data signals in a broadband structure. The system can be used for services built on the internet protocol (IP) and for providing access to end users.

### PRIOR ART

Prior art systems normally use cable TV networks (Docis standards), xDSL in public telephone networks or cable, such as CAT (CAT 5, 6 or 7). In cable TV networks there are limitations with regard to bandwidth restrictions and bandwidth use for downlink and/or uplink. Amplifiers and other devices also limit the use of such networks i.e. head end containing D1, D2 and D3 to end users. In these systems some kind of wire is used as a transfer medium. In apartment houses (on D3 level) there is typically no need for amplification in either direction.

Transmission of modulated information through copper wires in local public telephone networks is limited by for instance the distance between a telephone station and terminals or end users. Also the selected transmission speed and possible other users on the same cable branch limit such a transmission as a result of physical properties, such as bandwidth, noise, crosstalk and interference of the cables. These limitations result in undesired restrictions in the transfer of streaming IP flows in services such as high definition TV and video on demand. The limitations also constitute a drawback when new services are developed.

Generally in wired and wireless communication systems different types of modulation of carriers are used together with signal processing. Wireless transmission using the air as a transfer medium is highly limited by air attenuation, physical obstructions such as walls and floors. Well-chosen frequencies improve the situation. Also a higher transmit power can be used but this is a drawback when there is an intention to restrict contamination by electromagnetic radiation.

More and more services are made available requiring even higher bandwidths and bit transfer rates that cannot be provided easily and efficiently with existing techniques. There is a further need also for higher bit rates in both directions to support active end users. In this respect is has been considered too expensive and time consuming to install fibres or cables that can provide high capacity services in existing buildings, sub-urban and city areas.

### SUMMARY OF THE INVENTION

An object of the present invention is to overcome drawbacks mentioned above and to provide a system that will allow a more efficiently usage of existing wired and wireless networks and communications solutions based on wireless standards for fixed and/or nomadic and/or mobile services. In accordance with the invention it will be possible also to transparently transmit digital signals between stations through any wire and/air medium and/or a combined wired and wireless network including in the latter case at least one exchange of medium, such as cable to air or air to cable. The digital signals can be transmitted in both directions between terminals. Fixed broadband access as well as public broadband access indoors as well as outdoors are included.

In accordance with the invention signals that are transmitted in a first communication system based on a first medium are received and converted in a first media converting means. After the conversion the signals are transmitted in a second communication system based a second medium. The converted signals are then converted in a second step in a second media converting means for further transmission in a different medium. The different medium can be equal to the first medium.

Each of the stations uses digital modems in which base bands are converted to suitable analogue carrier/carriers at selected frequency bands so as to transfer data over different media, such as air or any type of cable, depending on standards of available networks. Different systems can be isolated by filtering techniques and/or by, selection of appropriate frequencies. It is possible also to adapt impedance, signal level and/or frequency band to allow the transfer of data through the wires. Also radio standards based on time division duplex and/or frequency division duplex and/or half frequency division duplex can be used when data are transferred through the wires.

When wires are used for the communication the frequency of a carrier or carriers transmission (strictly speaking a radio channel) is selected to avoid interference with other stations and/or other applications that use the same medium in parallel. However, the frequency is selected taking the physical properties of the wire and the subscriber's terminals into consideration.

In one embodiment in accordance with the invention a first medium is air, the second medium is a coaxial cable and the different medium again is air. Another embodiment in accordance with the invention allows that the second medium consisting of a cable system is the only medium to be used. In such case wireless stations communicate with each other via coaxial and/or telecom and or data cable network systems via medium conversion where radio signals are adjusted to an appropriate carrying frequency band for the used medium and or to a selected frequency that include avoidance with other possible co-located signals like standards cable-tv-services, etc. which are applied on the same network system.

In other embodiments other medium and or medium conversions are used in various combinations between a first and a second etc. to arrange transparent transfer of carriers via analogue pipes arranged for wireless stations in communications. In accordance with the invention it is possible to repeat the media conversions steps in a non-limited way as may be required in each specific application.

By using a wired network or a wired network as part of a combined network it is possible to overcome restrictions and limitations of a first medium via air by wireless stations specifically in dense user environment, due to signal degradation through air, in walls, ceilings and roofs and other obstacles. Signals from wireless stations using an existing cable medium for example to establish communication within a building to overcome obstacles are converted via the medium converter to suit the specific cable medium to reach another station which in its turn is connected to a corresponding station connected to a similar medium converter.

Signals from stations in the wireless communication network that are received and or transmitted are converted to suit a second medium, such as coaxial cable, copper wires or fibre cables, and then transferred through the second medium to stations that utilize the second medium. During conversion the code structure and modulation of the original signal are maintained.

The invention can be implemented in existing wireless standards or using such standards such as IEEE 802.11x, IEEE 802.16x, IEEE 802.15x, other IEEE standards including UMTS not excluding DOCIS. Additionally other de-facto wireless standards evolving standards or solutions that are arranged to establish communications between stations via modulated carriers through air or wires or in combination are included. Different topologies for communication between stations include point-to-point, point-to-multipoint and multipoint-to-multipoint.

Any existing wired technology can be included as a medium in accordance with the invention. Examples of such technologies are cable-TV, telephone communication, computer networks and electrical power distribution. The physical implementations include coaxial cable, twin wires for telephone communication, copper wires for data transmission and/or telephone communication and/or fibre cables i.e. for all types of data transmission having a spectrum available that enables transparent carrying of modulated carriers on suitable frequency bands.

Wireless access to a network or the internet can be provided inside or close to a building where an installation in accordance with the invention is implemented. Means arranged outside the building connects a WLAN, WiMAX and UMTS or similar system to a wired network part of the installation inside the building.

On the reverse means arranged inside the building including arrangements of access points in a basement or similar location to access apartments via coaxial cable overlaid on cable TV standards. Additionally these access points can also be used to reach access feasibilities outside the building. Such cable arrangements indoor include star/branch and tree structures.

The communication between the stations includes a transparent transmission of digital information. Antenna applications and stations involved will not be aware of the change of media during the transmission. End users at the stations using different medias and communication techniques will not be aware of the change of media during the transfer of information.

### BRIEF DESCRIPTION OF THE DRAWINGS

The invention will now be described in more detail with reference to embodiments thereof shown in the accompanying drawings.

FIG. 1 is a schematic view showing a first embodiment of the invention.

FIG. 2 is a schematic view showing a second embodiment of the invention.

FIG. 3 is a schematic block diagram of a media converting means included in the embodiment shown in FIG. 1.

FIG. 4 is a diagram showing schematically the attenuation of a cable in a TV cable network.

### DETAILED DESCRIPTION

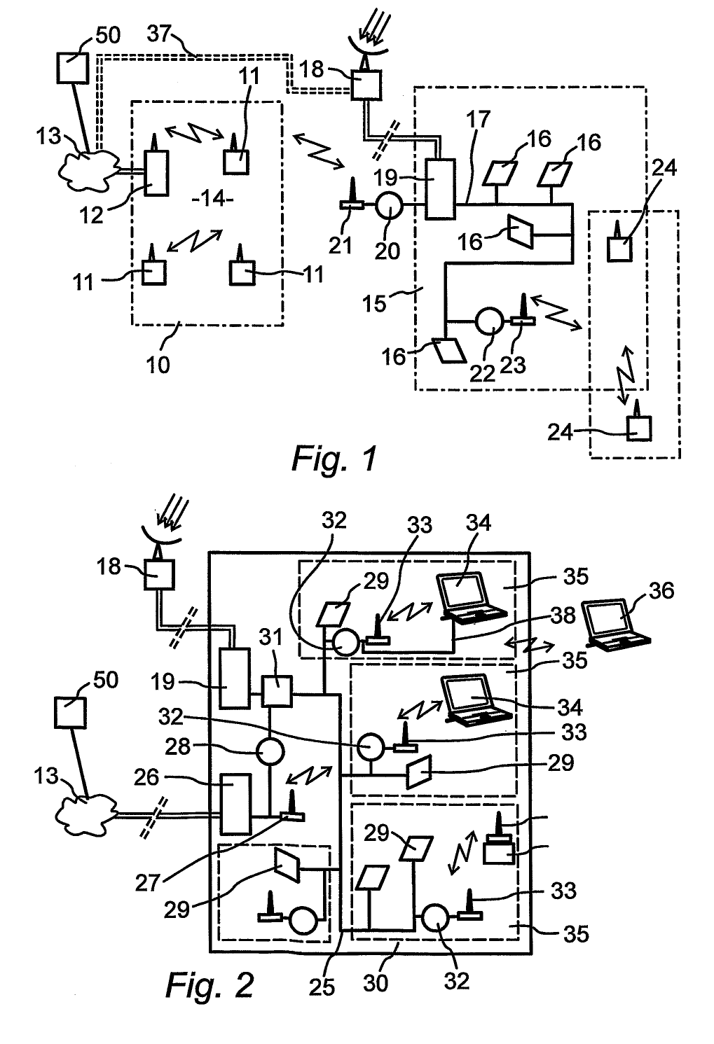

In the embodiment shown in FIG. 1 a wireless first network 10 includes a plurality of first stations 11 and a combined gateway and wireless access point 12 providing the first network 10 with services such as access to the internet 13. The stations 11 communicate with each other and with the gateway 12 through air 14 as a first transfer medium. Radio signals are broadcasted between the access point 12 and the first stations 11.

A wired second network 15 is provided in a building or site that can include a plurality of buildings. The second network 15 includes a plurality of second stations 16 connected through a wire 17 forming a second medium. In the shown embodiment the second network is a conventional cable network in a building including a coaxial cable and/or a telecom and/or data cable. The cable network receives digital video signals from a satellite receiver 18 that can be located distant from the building. A dashed line 37 indicates that the cable network also can be connected to the internet to provide internet access to the second stations 16.

A connecting box 19 is arranged for instance in a basement or other suitable location in the building for distributing the video signals in the cable network. The stations of the second network include a set top box or similar device that can be connected to a TV set considering cable TV network applications or telephone networks for telecom cables or data cables for data applications. The set top box is connected to a TV outlet or corresponding terminal of the cable network.

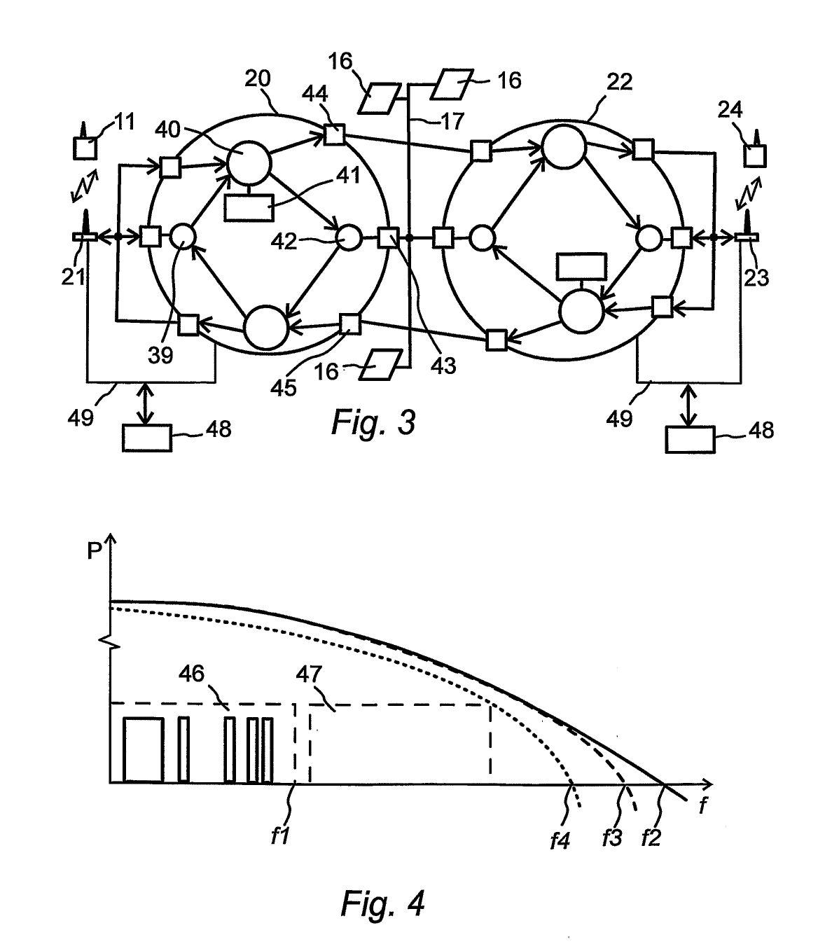

In accordance with the invention a first media converter 20 is connected to a first receiving and transmitting means 21, such as an antenna or antenna systems in for instance a MIMO system, that is arranged to communicate with the wireless first network 10. The first media converter 20 is also connected to the wired second network 15. In the shown embodiment the connection is made at the connecting box 19. Signals broadcasted in the wireless first network 10 are received in the receiving and transmitting means 21 and forwarded through the wired second network 15 after being converted in the first media converter 20. The conversion of the signal in the first media converter 20 does not include any change of coding or modulation of the radio signal. An embodiment of the media converter is described below with reference to FIG. 3.

A second media converter 22 is connected to the second network 15 and detects signals originating from the wireless first network 10 and being transferred through the second medium at a frequency scheme that do not interfere with the frequency scheme used by the cable network. These detected signals are converted in the converter 22 and transmitted to the air through a second receiving and transmitting means 23. Air is now the transfer media again. Again the conversion of the signal in the media converter does not include any change of coding or modulation of the original signal.

A plurality of third stations 24 communicates through air with each other and with the first stations 11 through the second receiving and transmitting means 23 and the second network 15. Signals originating from the wireless first network 10 can be received by the third stations 24 as if they were physically located in the vicinity of the first stations 11. The communication between the first stations 11 and the third stations takes place in both directions. It is possible also for the first stations 11 as well as the third stations 24 to access the internet 13.

A network management control and supervision centre 50 is connected to the internet 13 and is able to reach the multiple stations 11, 24, first receiving and transmitting means 21 and second receiving and transmitting means 23 via IP networking protocols or similar.

An alternative embodiment in accordance with the invention is shown in FIG. 2. Here a conventional cable network 25 is connected to a satellite receiver 18 through a connecting box 19 in a way similar to the embodiment shown in FIG. 1. A plurality of end users 29 are connected to the cable network 25 in one or multiple buildings or sites 30. Each end user has a set top box or similar device allowing him to connect a TV set to the cable network.

A coaxial cable network of standard type normally operates on a bandwidth up to 860 MHz for standard cable TV services even though most systems physically are capable of operating at considerably higher frequencies. The capacity at bands within cable or outside cable TV standards and higher frequency bands is utilized in accordance with the invention as will be described below as an example.

A connection 26, such as a logical gateway, to the internet 13 or another service is connected to a first receiving and transmitting means 27, such as an antenna or an antenna combined with a station, located inside or outside the building 30 from where it may communicate with other receiving and transmitting means through air and/or cable. The gateway 26 and the receiving and transmitting means 27 form an access point in a wireless network. Multiple access points of this type can be provided in accordance with the invention. Signals are transmitted to stations that are provided with hardware and software for wireless communication, such as IEEE 802.11x WLAN standards. Due to signal attenuation within the building the service range through air is very limited. Users located within the building but at some distances from the access point will normally not be able to access the internet or other services through this route at an acceptable speed.

In accordance with the invention a first media converter 28 is connected to the gateway 26 at the same functional level as the first receiving and transmitting means 27, that is at a radio frequency level and/or intermediate frequency level. In the first media converter 28 signals at the radio frequency level to and from the first receiving and transmitting means 27 are converted to be suitable for transmission in the cable network transparently. The first media converter 28 is connected to the cable network through a mixer 31 that will allow signals to and from the gateway 26 to be transferred over the cable network without interfering with the cable TV services.

A second media converter 32 is provided at the location of an end user 29 and is connected to the cable network 25. The second media converter 32 is functionally similar or identical to the first media converter 28. Also at the location of the end user 29 there is provided a second receiving and transmitting means 33 similar or identical to the first receiving and transmitting means 27. The second media converter 32 and the second receiving and transmitting means 33 form a micro cell that will allow user access to services that are available through the gateway 26. The micro cell in a building or a macro cell to reach out of the building which can be based on for instance WLAN, Wi-Fi, WiMax or UMTS.

In accordance with the invention the second receiving and transmitting means 33 will function as an extension of the first receiving and transmitting means 27. Computers and other equipment that are located not too distant away from the second receiving and transmitting means 33 and that are provided with means for a wireless connection will have access to the internet 13 and/or other types of networks through the cable network 25.

Each end user 29 can be located in separate premises 35 in the building 30 and will have full access from a computer 34 such as a laptop through the gateway 26 as if the end user was located in the vicinity of the first receiving and transmitting means 27. This applies also when the computer 34 is connected to the second receiving and transmitting means 33 through a separate cable 38.

Since the communication to and from the end user includes a wireless connection there will be a “leakage” of the service provided by the gateway 26 from the premises of the end user to other parties located in the vicinity of the second receiving and transmitting means 33, such as an external computer 36. This “leakage” can be utilized by arranging functions and means to allow other users to subscribe to internet access services. Such functions and means can include authorization, authentication and security arrangements.

FIG. 2 also illustrates schematically an interconnection or cable 38 between the second media converter 32 and the computer 34. This interconnection can include a connection carrying an rf signal if a corresponding wireless station is built into the computer 34 and or a standard digital interface for a normal digital interconnection such as RJ45, Firewire, USB etc.

One embodiment of a media converter, such as the first media converter 20, is shown in FIG. 3. The media converter is connected to a first receiving and transmitting means 21, such as an antenna or an antenna system for providing a wireless communication with a first station 11 being part of a wireless first network. The wireless communication between the first station and the receiving and transmitting means 21 can be based on Time Division Duplex (TDD) and/or Frequency Division Duplex (FDD) and/or half Frequency Division Duplex.

The media converter 20 is connected to a wired second network 17 including a plurality of second stations 16. FIG. 3 also shows a combination where a TDD station is arranged for half duplex (HFDD). When a station is based on TDD it is connected to a first circulator 39. Signals aimed for a third station 24 is passed through a mixer 40, which is fed by an oscillator 41, and further on to a second circulator 42. In the mixer 40 the frequency of the signal can be changed to a frequency that is appropriate for further transmission in the second network 17 for instance so as to avoid interference with other signals appearing on the cable and/or to match transfer characteristics of said second network.

An amplifier (not shown) can be included in the mixer 40 or provided between the mixer 40 and the second circulator 42. In a similar way a filter (not shown) normally is provided in or in combination with the mixer 40 or arranged between the mixer 40 and the second circulator 42. The second circulator 42 is connected to an impedance adapter 43, which is used adapt the impedance to an appropriate value for transferring the signal to the second network 17. In a FDD or TDD to half FDD application output means 44 and input means 45, respectively, are used to transfer signals from and to the media converter 20.

A controlling or supervising functional unit 48 is connected meant to the medium converters, 20 and or 22 via a digital interface 49 via receiving and transmitting means 21, 23 respectively and or any other station and or via a IP network and management centre.

A second media converter 22 is connected in a similar way to the wire 17. The second media converter 22 comprises similar or identical means as compared to the first media converter 20. It is apparent from FIG. 3 that the second media converter 22 operates the same way as the first media converter 20 and no further description is necessary in this respect.

In more complex applications a plurality of systems in accordance with the invention is used in combination. Receiving and transmitting means used by different systems, for example MIMO based systems, can operate at overlapping frequencies when air is the transfer medium for radio signals. After conversion in a plurality of media converters including frequency transformation the frequencies of the different systems can be separated and transferred through a single cable or wire without interference. After transfer through the cable and a conversion and frequency transformation the signals are again transmitted through air, also on overlapping frequencies.

The attenuation of a cable in a TV cable network schematically is shown in FIG. 5. However, approximately the same properties will apply for other systems. The y axis depicts the carrier signal level S and the x axis depicts the frequency f. A frequency value f1 is an approximate upper limit for an existing service 46 of a cable in a cable network. In an application where the cable is a coaxial cable and the service is cable TV f1 is equal to approximately 860 MHz. Frequencies above f1 but below a theoretical upper limit f2 are available for systems utilizing the present invention for 47.

In practice the available frequency space is limited to a lower frequency f3 by other equipment used in or connected to subscriber's outlets. A further limitation to a frequency value of f4 is the result of attenuation properties of the outlet, filters and directional couplers. Frequency bands below f1 that are not used by the existing service can be used by the system in accordance with the invention.

1. A system for distributing radio band signals in a broadband structure including a first network and a second network, characterised in
that said first network is connected to a second network through a first media converting means for converting the radio band signals for transfer through the second network,
that said second network is connected to at least a second media converting means, and
that said media converting means are designed to maintain code structure and modulation of the radio band signals.

2. A system for transmitting radio signals in a broadband structure including a first network, said first network operating on air as a first medium, characterised in
that said first network is connected to a second network through a first media converting means for converting the radio signals for transfer through the second network, said second network operating on wire as a second medium,
that said second network is connected to a third network through at least a second media converting means, said third network operating on a medium different from the second medium,
that said media converting means are designed to maintain code structure and modulation of the radio signals and
that stations of the first network are operatively connected to stations of the third network.

3. A system in accordance with claim 2, wherein
said media converting means (20; 22) comprise an impedance adapter (43).

4. A system in accordance with claim 2, wherein
said media converting means (20; 22) comprise a frequency converter.

5. A system in accordance with claim 2, wherein
said media converting means (20; 22) comprise a mixer (40) and an oscillator (41) operatively connected to the mixer (40).

6. A method for distributing radio band signals between stations in a broadband structure, characterised by
converting radio band signals transmitted from a first station to intermediate signals for transfer through a wire connection while maintaining code structure and modulation of the radio signals, and
receiving the intermediate signals transferred over the wire connection, converting the intermediate signals to radio band signals while maintaining code structure and modulation of the radio signals.

7. A method for transferring radio signals between stations in a broadband structure, characterised by
converting radio signals transmitted from a first station to intermediate signals for transfer through a wire connection while maintaining code structure and modulation of the radio signals,
receiving the intermediate signals transferred over the wire connection,
converting the intermediate signals to radio signals while maintaining code structure and modulation of the radio signals,
transmitting the converted radio signals and
receiving the converted radio signals in a second station.

8. A method in accordance with claim 7, wherein the radio signals are frequency transposed to a frequency suitable for transmission through an existing wire.

9. A method in accordance with claim 7, wherein the radio signals are adapted to an impedance suitable for transmission through an existing wire.
